(19) United States
(12) Patent Application Publication
(10) Pub. No.: US 2024/0200157 A1
(43) Pub. Date: Jun. 20, 2024

(54) COOLING SYSTEM FOR A METALLURGICAL FURNACE

(71) Applicant: PAUL WURTH S.A., Luxembourg (LU)

(72) Inventors: Giang Kien LY, Luxembourg (LU); Nicolas MAGGIOLI, Thionville (FR)

(21) Appl. No.: 18/286,830

(22) PCT Filed: Apr. 29, 2022
(86) PCT No.: PCT/EP2022/061540

§ 371 Date: Oct. 13, 2023

(30) Foreign Application Priority Data
Apr. 30, 2021 (LU) LU500112

(51) Int. Cl. C21B 7/10; F27D 9/00; F27D 19/00

(52) U.S. Cl. CPC C21B 7/10; F27D 9/00; F27D 19/00; F27D 2009/0013; F27D 2009/0021; F27D 2009/0067

(57) ABSTRACT

A cooling system for a metallurgical furnace includes a plurality of cooling arrangements having each a set of cooling elements arranged to extract heat from the furnace, the cooling elements having each at least one internal cooling channel for a coolant fluid, where the cooling elements are fluidly connected within each cooling arrangement; at least one discharge piping associated with each cooling arrangement for discharging the coolant fluid towards a main collector, where a flow regulating arrangement is serially mounted with the discharge piping and configured to control a flow rate of the coolant fluid therethrough and hence through the cooling arrangement, where the flow regulating arrangement includes a calibrated orifice defining a default, minimal flow cross section for the coolant fluid and a regulating valve selectively operable to define a variable, additional flow cross-section.

### TECHNICAL FIELD

The disclosure relates to a cooling system for a metallurgical furnace comprising a plurality of cooling arrangements.

### BACKGROUND

Cooling arrangements in metallurgical furnaces are used to transfer heat from said furnaces, such as e.g. a blast furnace, to a coolant medium/fluid. For this reason, cooling arrangements of such furnaces present a plurality of cooling elements having internal coolant channels for guiding said coolant fluid. The cooling elements (e.g. cooling plates or staves) may be arranged along furnace walls to protect them from the high operating temperatures. The coolant fluid may for example be water. In order to control and operate cooling arrangements of metallurgical furnaces, it is necessary to provide an adequate cooling system.

At present, metallurgical furnaces require cooling arrangements having a plurality of cooling elements arranged in, at or on the furnace. However, these cooling arrangements are usually regulated by means of control systems which are arranged upstream of the cooling arrangement. JPS5696005A discloses such a control system. These cooling systems of a metallurgical furnace present disadvantages in terms of reaction time, the amount of fluid used to cool the furnace and in view of the automatic regulation of the fluid flow rate, wherein the flow rate usually depends on the heat load transferred to the cooling elements.

In addition, during the operation of a furnace, it often occurs that at least some areas, respectively cooling elements, of the furnace are subjected to more wear/abrasion than other areas. Similarly, some areas, respectively cooling elements, of the furnace are subjected to a particular high heat load while other areas are exposed to a lower heat load. This may lead, for example to occurrences, wherein the copper staves mounted in areas of high heat load may be submitted to abrasion or smelting. This in turn enhance the risk for failure of these elements and can even lead to a complete breakdown of the furnace. For this reason, there is a general need for a reliable and cost-effective operable cooling system of a metallurgical furnace.

### BRIEF SUMMARY

The present disclosure provides an improved cooling system for a metallurgical furnace.

The present disclosure relates to a cooling system of a metallurgical furnace comprising a plurality of cooling arrangements comprising each a set of cooling elements (typically arranged along a furnace wall), the cooling elements having at least one internal cooling channel for a coolant fluid. The cooling elements are fluidly connected within each cooling arrangement, typically in series. At least one discharge piping is associated with each cooling arrangement for discharging the coolant fluid towards a main collector.

It will be appreciated that a flow regulating arrangement is serially integrated within the discharge piping and configured to control a flow rate of the coolant fluid therethrough and hence through the cooling arrangement. The flow regulating arrangement includes a calibrated orifice defining a default, minimal flow cross section for the coolant fluid and a regulating valve selectively operable to define a variable, additional flow cross-section.

The present disclosure is based on the finding that a particular arrangement of the elements of a cooling system of a metallurgical furnace allows to provide a modified, automated cooling system which may precisely adjust the flow rate of a fluid within plurality of cooling arrangement each having set of cooling elements. Each set of cooling elements may advantageously be arranged vertically or horizontally in, at or on a sector, e.g. an angular sector or a quadrant, of a (blast) furnace, such that the flow rate of the medium may be automatically adjusted to different heat loads present in different sectors/quadrants of the furnace.

The present disclosure is also based on the finding that an installation of a cooling system of a metallurgical furnace according to the disclosure is relatively cost efficient and may be implemented particularly effortlessly on, in or at already existing cooling arrangements and/or furnaces.

The present disclosure is also based on the finding that an efficient self-adjusting mechanism of a cooling system of a metallurgical furnace may be provided when said cooling system of a metallurgical furnace is located downstream of the cooling arrangement. The self-adjusting mechanism of the cooling system allows that the flow rate of the cooling fluid within predefined set of cooling arrangements, respectively set of cooling elements, may be automatically controlled. In this context, the present cooling system is suited to perform a selective opening of a regulating valve arranged within a specific discharge piping of a cooling arrangement, such that the fluid flow rate may be increased only in the furnace sectors where it is actually needed while the other remaining cooling elements arranged in the other sectors may continue operating with a constant, e.g. a reduced, water flow rate. In addition, the proposed cooling system may permit a constant flow of the fluid to a main collector at each moment during the operation of the furnace, such that a risk for a standstill of the fluid is effectively reduced.

The present disclosure is also based on the finding that, depending on the heat flux of the (blast) furnace, the proposed cooling system may allow to operate a cooling arrangement with merely only one pump instead of two (the pumps are generally arranged upstream of the cooling arrangements), wherein the working pump may provide merely 60% to 80% of the nominal water flow rate. The flow rate of the working pump may thus be, for example, in a volume range of approximately 1250 m³/h to 1750 m³/h, depending on the size of the (blast) furnace.

It has further been surprisingly found by the inventors that the present disclosure may also be suitable to generate, maintain and to maximize “scaffold” in front of specific and determinable cooling arrangements, respectively cooling elements, in particular in high heat load areas of the furnace. “Scaffold” generally refers to an accumulation of adherent, partly fused material forming a shelf-like or dome-shaped structure, respectively obstruction on the inner wall of a furnace, in particular on or above the tuyeres, respectively tubes, of a blast furnace. The scaffold in front of the cooling elements in high heat load areas of the furnace may function as a protection against an excessive heat load and/or an abrasion or erosion wear of the elements of the furnace. In addition, it has been found that the generated scaffold in front of set of cooling elements of a cooling arrangement may even allow to reduce the fluid flow within said cooling element, which in turn leads to cost reductions and energy savings, as for example with respect to the amount of coke required during the operation of the furnace. As a further consequence, and due to the fact that the amount of cooling fluid, e.g. water, is reduced, the furnace can be operated in a more environmentally friendly way and with reduced carbon dioxide emissions.

In this connection, the control of scaffolding is particularly efficient where the cooling arrangements are configured as generally vertically extending groups of cooling elements, covering an angular sector of the furnace (one or more columns of cooling elements). This allows controlling different heat fluxes at different circumferential locations of the furnace. It is thus easier to act on scaffolding phenomena that occur locally at the furnace inner periphery.

“Cooling system of a metallurgical furnace” generally refers to a group of related devices, elements and/or objects forming a structure for controlling, respectively regulating, adapting, modifying, varying and/or setting parameters of a cooling arrangement or a plurality of cooling arrangements. The cooling arrangements of the plurality of cooling arrangements may be of similar or different size and/or structure. The cooling system of a metallurgical furnace may comprise, for example, one or more devices for controlling and/or regulating a flow of coolant, e.g. a fluid, flowing, respectively circulating, through the cooling arrangement.

“Cooling arrangement”, respectively a plurality of cooling arrangements, generally refers to a composition of cooling elements, e.g. cooling panels or staves, which are used and configured for cooling, respectively for transferring heat from an object, such as a metallurgical furnace, to or by means of a fluid. Heat may be generally transferred from the furnace to the cooling elements by various mechanisms, such as thermal radiation, conduction and/or convection. A cooling arrangement for a metallurgical comprises one or more cooling elements which are mounted in, on or at high heat areas of the furnace.

“Metallurgical furnace” generally refers to any sort of industrial furnace, in particular blast furnaces, smelting furnaces, electric arc furnaces, heating furnaces, shaft furnaces, hood furnaces, conveyor belt furnaces, or similar furnaces.

“Set of cooling elements” generally refers to a plurality of cooling elements, such as e.g. cooling panels and/or staves, operatively connected to each other, such that the plurality of related cooling elements forms a set, wherein a “set” generally refers to a number of elements of the same kind or similar kind that are used together. Each cooling element is provided with at least one internal coolant channel (generally a plurality), through which the fluid flows during an operational state of the cooling arrangement. Each cooling arrangement may be mounted, installed, set, or forming part at, in or on a sector/region, respectively a quadrant, of the furnace. In particular, each set of cooling elements of a cooling arrangement may be mounted, respectively arranged, along an inner and/or outer furnace wall. The cooling elements may be connected in series. “Connected in series” refers to an arrangement, wherein at least one cooling element is in fluid communication with a downstream and/or upstream cooling element of the same cooling arrangement. Where the cooling elements comprise a plurality of internal coolant channels, each coolant channel of a cooling element is serially connected with the corresponding cooling channel of the neighboring cooling element (upstream and downstream).

In the context of metallurgical furnaces the coolant fluid may generally be water, or an aqueous fluid, although other appropriate coolants may be employed.

“Discharge piping” generally refers to a quantity or system of pipes configured to conduct the cooling fluid from a cooling arrangement towards the main collector. The discharge piping may comprise a first section with individual pipings for collecting the coolant from the coolant channels, the pipings of the first section converging to a second section with the flow regulating arrangement. An intermediate collector may namely be connected to receive the flow from the pipings of the first section, and distribute it to a single piping in the second section, wherein the flow regulating arrangement is serially connected.

The “intermediate collector”, respectively intermediate (collector) pipe, may likewise be comprised by the discharge piping. The term “intermediate collector” generally refers to a tube, pipe or a tubular or cylindrical object, channel, hollow part or passage, or any other type of a void body configured to conduct a liquid, gas, and/or the fluid. The intermediate collector is thus part of the discharge piping and arranged upstream of the regulating arrangement and downstream of the introducing device. In general, the intermediate collector may collect the heated fluid before said fluid is conducted, respectively guided to the regulating arrangement and/or the main collector. The intermediate collector may further be configured to collect the fluid exiting from a plurality of pipings connecting the internal coolant channels and/or be configured to distribute the collected fluid into a one or more flow regulating arrangements.

“Regulating arrangement”, respectively regulation arrangement, generally refers to a subsystem of the discharge piping that is configured to regulate and/or determine the flow rate and other physical properties of the fluid. In embodiments, the regulating arrangement is located, respectively arranged downstream of the intermediate collector and upstream of the main collector. For example, the regulating arrangement may permit to regulate, respectively determine or adjust, a flow rate, and hence also a volume flow as well as a pressure of the fluid within the cooling arrangement as well as within the main collector. The regulating arrangement may further for example comprise a first and a second conduit, wherein the first conduit and the second conduit are in fluid communication with one another. The first conduit may comprise a first regulating valve selectively operable to define a variable, flow cross-section for the cooling fluid. “Regulating valve” generally refers to an object or constructive element allowing to regulate properties of the fluid flow and/or stream. For example, the regulating valve may be formed as an automatic valve configured to allow a variable adjustment of the flow rate of the fluid. The regulating valve may be arranged in the first conduit and connected to a control unit for operating said first regulating valve. In other words, the regulating valve may be configured to variably adjust the flow rate of the fluid. The second conduit may comprise a calibrated orifice or, alternatively, the second conduit be connected to a calibrated orifice of the first regulating valve, such that the second conduit allows that a default flow of the fluid is conducted at each moment to the main collector. The regulating arrangement may be connected in series with the main collector.

“Main collector”, respectively discharge pipe, generally refers to a pipe for discharging the fluid after said fluid has passed and/or been subjected to the regulating arrangement. The main collector is in fluid communication with the intermediate collector and arranged downstream of the intermediate collector.

“Orifice” refers to an opening, such as a mouth, a hole or a passage, through which the cooling fluid may pass. The term “calibrated orifice” generally refers to a standardized orifice, e.g. an orifice which has been precisely designed, respectively measured or configured, and mounted to adjust precisely for a particular function, e.g. the passage of a specific, default, minimum flow of the fluid. The calibrated orifice may thus define a corresponding default, minimal flow cross section for the coolant fluid, whereas the regulating valve may be selectively operated to define a variable, additional flow cross-section.

“Default, minimal flow cross section” generally refers to a cross-section of a pipe or tube configured to let pass a minimum flow or stream of the fluid, such that the fluid may exit the regulating arrangement at each moment. Due to the default, minimal flow cross section of the calibrated orifice, the flow of the fluid within the cooling arrangement is prevented from coming to a standstill. In other words, the calibrated orifice is configured to generate and guide, respectively conduct, a default flow of the fluid to the main collector according to a predeterminable minimum flow rate.

“Control unit” generally refers to a system which comprises at least one of the following: an electronic system, a programmable control unit, a computer, a processor, a storage fluid, a user interface, a program, a software application or a similar element. The control unit may be configured to receive signals provided by sensors. The control unit may be further configured to operate the first regulating valve within the first conduit by transmitting electronic signals to an actuator.

In an embodiment, the regulating valve is an automatic valve controlled by a control unit depending on sensor signal(s) received from one or more sensor device(s) arranged at predetermined locations in the cooling arrangements. “Sensor device” refers to an element, system or structure configured for detecting, measuring, determining or monitoring changes or conditions of an environment. The sensor device, respectively sensor, may be further configured to send information, for example a signal representing a (process) parameter such as e.g. a temperature of the fluid circulating within the cooling arrangement. The information may be sent, respectively transmitted, by the sensor device to the control unit. Thanks to the sensor device, the control unit may determine whether the measured value meets a predefined value or a range of predefined values. In such a case, the control unit may cause the first regulating valve to open or close (in part or entirely) and thereby to adjust the flow rate within the regulating arrangement. In consequence, also the flow rate of the fluid within the cooling arrangement arranged upstream of the regulating arrangement is adjusted correspondingly to a predefined flow rate or predefined range of flow rates. The first regulating valve may further comprise or consist of an automatic valve having an actuator, wherein the actuator is connected to the control unit. The actuator may for example be an electric or pneumatic actuator.

In an embodiment, the regulating valve includes a movable valve member, wherein the calibrated orifice is arranged in the valve member. The calibrated orifice may thus be a part of the valve body, such that the valve provides at least a passageway to the fluid.

In an embodiment, the regulating arrangement comprises a first conduit and a second conduit, wherein the first conduit and the second conduit are arranged in parallel to one another, wherein the second conduit comprises the calibrated orifice and wherein the first conduit comprises the regulating valve. For example, the calibrated orifice arranged within the second conduit may be part of an orifice plate. “Orifice plate”, respectively a restriction plate, generally refers to an element configured for determining a flow rate of a fluid and/or for reducing pressure and/or for restricting a flow. An orifice plate may be formed as a thin plate having a calibrated orifice in it. The orifice plate may for example be placed in the second conduit. When a fluid, respectively the fluid, passes through the orifice plate, its pressure increases upstream of the orifice whilst, downstream of the orifice, its velocity increases as its fluid pressure decreases.

In an embodiment, the regulating valve is configured as a butterfly valve. A butterfly valve may refer to any sort of adjustable vale, in particular valves having a closing mechanism presenting a rotatable element, such as a disk. Butterfly valves may be operated relatively fast and my thus be used to quickly adjust a flow rate of a stream.

In an embodiment, the sensor device comprises or consists of at least one of the following: a temperature sensor, a flow sensor, a pressure sensor. A temperature sensor may be any sort of sensor suited to determine a temperature, e.g. a temperature of the fluid, and/or a temperature change. A flow sensor may be any kind of sensor configured to determine a flow of the fluid. A pressure sensor may be any kind of sensor configured to determine a pressure of the fluid.

In an embodiment, the first conduit is configured as a bypass of the second conduit; or wherein, optionally, the second conduit is configured as a bypass of the first conduit. “Bypass” may generally refer to any arrangement of tubes, pipes, valves and/or hollow bodies and/or similar elements used for redirecting a stream. The arrangement of a bypass allows that a predeterminable minimum flow, respectively a default flow, may exit the regulating arrangement towards the main collector. As a consequence, a standstill of the fluid within the cooling arrangement is prevented.

In an embodiment, the regulating arrangement further comprises a second temperature sensor and/or a flow meter and/or a pressure sensor and/or a manual valve. The second temperature sensor and/or the flow meter and/or the pressure sensor may be electrically connected to the control unit. Due to the arrangement of a second temperature sensor and/or a flow meter and/or a pressure sensor, the control unit may determine additional process parameters of the fluid flowing within the regulating arrangement. The manual valve may permit a manual blocking of the regulating arrangement, e.g. when maintenance is required.

In an embodiment, the cooling elements are in fluid communication with one another, wherein the cooling elements are arranged vertically or horizontally to one another. The arrangement of cooling elements on a furnace wall permits that said cooling elements may be arranged horizontally or vertically with respect to one another. For example, when a plurality of cooling arrangements, e.g. four cooling arrangements, each comprising a plurality of cooling elements, is mounted to a furnace, different sections of the furnace may be cooled by the horizontally or vertically arranged cooling element at different flow rates. In consequence, the fluid flow may be increased in areas, where a high heat load is transmitted to the cooling elements, whereas the fluid flow may be decreased in areas, where normal or low heat loads are transmitted to the cooling elements.

In an embodiment, each cooling arrangement of the plurality of cooling arrangements is arranged in a quadrant of a furnace. “Quadrant” generally refers to an angular sector the furnace. Although a quadrant strictly designates 90° of the circumference, it is also used herein by extension to designate smaller angular sections, even corresponding to a single column of cooling elements. The arrangement and separation, respectively the division, of the cooling arrangements into different quadrants permits that different angular portions of the blast furnace may be cooled differently. In consequence, the generation of hot spots within the furnace during its operation may be prevented.

It may be noted that the control by sections or quadrants strikingly differs from the usual connection of the cooling elements, which are typically connected in rows. Where the cooling elements are connected as rows, it is impossible to control differently a specific angular sector (quadrant).

In an embodiment, the discharge piping comprises an introducing arrangement, wherein the introducing arrangement comprises an exit line for conducting the fluid towards the intermediate collector, and wherein the exit line comprises at least one of the following: a further flow meter and/or a further temperature sensor and/or a shuttle valve and/or a venting device. The fluid may stream from the cooling arrangement via said introducing arrangement comprising the exit line to the intermediate collector, wherein the intermediate collector collects and distributes the fluid to at least one regulating arrangement. The discharge piping may comprise the introducing arrangement and the regulating arrangement. A (further) flow meter and a (further) temperature sensor permit an enhanced surveillance of process parameters, e.g. parameters related to the fluid circulating upstream the main collector. The shuttle valve as well as the venting device, respectively the vent valve, may be used or configured to detect leakages.

These and other aspects and features of the present disclosure also derive from the dependent claims, the attached drawings and the following description of the embodiments.

### BRIEF DESCRIPTION OF THE DRAWINGS

Embodiments of the disclosure are now described by way of example and with reference to the attached drawings, wherein

FIG. 1: is a principle drawing of an embodiment of the present cooling system in a metallurgical furnace;

FIG. 2: is a schematic view of another embodiment of the present cooling system comprising a plurality of cooling arrangements; and

FIG. 3 is a principle view of an alternative embodiment of the flow regulating arrangement.

### DETAILED DESCRIPTION

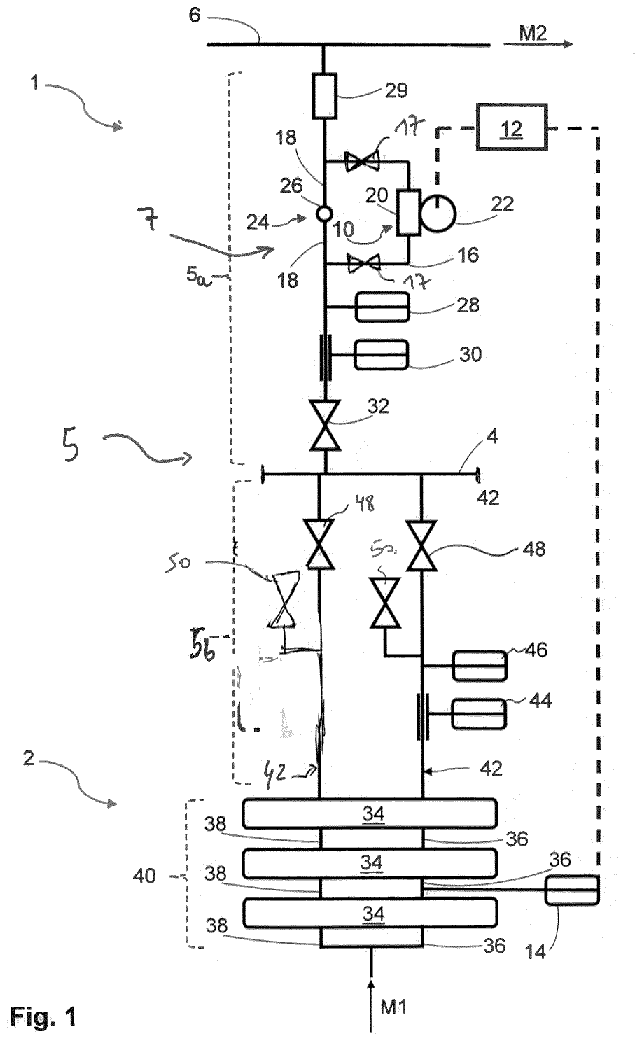

FIG. 1 is a principle drawing of a cooling system for a metallurgical furnace 1 according to an embodiment of the disclosure. FIG. 1 indicates a cooling arrangement 40 arranged in a region/sector 2 of the furnace (not shown), wherein the cooling arrangement 40 has a plurality of cooling elements 34 arranged along a furnace wall (not shown) and in fluid communication with one another via pipes 36, 38. Each of the cooling elements 34 may comprise one or more internal coolant channels (not shown), wherein each of the internal coolant channels of a cooling element 34 is connected to, respectively in fluid communication with, corresponding pipes 36, 38 connecting the cooling element 34 to a neighboring upstream and/or downstream cooling element 34. The cooling elements (namely their respective cooling channels) are preferably connected in series within the cooling arrangement 40. In the embodiment, the cooling elements 34 have two internal cooling channels.

Each cooling arrangement 40 is connected, on the downstream side, to at least one discharge piping 5, here comprised of two sections 5a and 5b, for discharging the coolant fluid towards the main collector 6.

The second section 5b of the discharge piping includes a flow regulating arrangement 7. The first section 5a is designed to convey the coolant discharged from the downstream most cooling element 34 towards the second section 5b. Preferably, a respective outlet piping 42 is connected with each coolant channel, as seen in FIG. 1. The two outlet pipings 42 are fluidly connected at the opposite end with an intermediate collector 4, from which the fluid flows into the second section 5b.

The second section 5b comprises a piping 18 connected at one end to the first section 5a, here through the intermediate collector 4, and at the opposite end to the main collector 6. The flow regulating arrangement 7 is serially integrated within piping 18 so that the entirety of the coolant flow entering the upstream piping section 5a must flow through the flow regulating arrangement 7 in order to reach the downstream section of piping 18 and thus main collector 6. As a result, the flow regulating arrangement 7 allows controlling the flow rate of the coolant fluid through the second section 5b and hence also through the corresponding coolant channels in the cooling arrangement 40.

In the embodiment shown by FIG. 1, the flow regulating arrangement 7 comprises a so-called orifice plate 24 that is integrated in piping 18. The orifice plate 24 comprises a calibrated orifice 26 that defines a default, minimal flow cross section for the coolant fluid through piping 18. The regulating valve 10 is selectively operable to define a variable, additional flow cross-section. The flow defined by orifice 26 is minimal in the sense that it is always open and fixed, and that the flow through regulating valve will add to the flow through orifice 26.

The cooling arrangement 40 is configured to transfer heat from the furnace, respectively a given sector/region 2 of the furnace, to the coolant fluid flowing inside the channels of the cooling elements 34. The arrows M1 and M2 indicate a flow direction of the coolant, wherein M1 represents an inlet flow of coolant at the cooling arrangement 40, whereas M2 indicates an exit flow of the coolant at the main collector 6. The coolant fluid flows from the cooling arrangement 40 via the first section 5a comprising the pipings 42 to the intermediate collector 4. The intermediate collector 4 collects and distributes the coolant fluid to the regulating arrangement 7 in section 5b. It should be noted, that in alternative embodiments, a plurality of regulating arrangements 7 (not shown in FIG. 1) may be arranged in parallel to one another between the intermediate collector 4 and the main collector 6.

The first section 5a may be equipped to monitor the state of the coolant fluid exiting the cooling arrangement 40. Accordingly, a flow meter 44 and a temperature sensor 46 are arrangement to monitor the fluid flowing through one of the pipings 42 of the first section 5a. A shuttle valve 48 (to shut off the flow) and a venting device 50 are also integrated in each piping 42. The flow meter 44, the temperature sensor 46, the shuttle valve 48 and/or the venting device 50 may be operable remotely by a control unit 12.

In the embodiment shown in FIG. 1, the regulating arrangement 7 is used to control the flow rate of coolant fluid. More specifically, as already indicated, the orifice plate 24 is integrated in piping 18. The orifice plate 24, typically exchangeable (e.g. flanged between two pipe ends), includes a calibrated orifice 26 that permits a default flow of the fluid due to its pre-defined, open cross-section. This orifice 26 is always open. Reference sign 16 designates another conduit, which is arranged parallel to and in fluid communication with the piping 18, connected upstream and downstream of the orifice plate 24. Conduit 16 thus forms a bypass with regards to the orifice plate 24.

Conduit 16 comprises a regulating valve 10 for variably adjusting the flow rate of the fluid therethrough. A control unit 12 is configured to operate the regulating valve 10. An actuator 22 is operatively coupled to actuate the regulating valve 10, namely to move the valve member in order to define a flow cross-section between 0 to 100%.

Due to the calibrated orifice 26 (in orifice plate 24), a predetermined minimum flow of the coolant fluid may be conducted towards the main collector 6 at all times. In case of necessity, e.g. when the control unit 12 determines that the temperature of the fluid exceeds a certain predetermined value, the regulating valve 10 is opened (by operating actuator 22), to increase the flow cross section. In this case a cross-flow for the fluid is increased, such that the volume flow of the fluid is likewise increased. The automated valve 20 may, e.g. be a butterfly or gate valve.

For example, let us suppose that the calibrated orifice 24 defines a flow cross-section D1 and the regulating valve 10 has a maximum flow cross-section D2 (i.e. when the regulating valve is open 100%).

In the default flow configuration, the regulating valve is closed and the flow through regulating arrangement 7 is thus only defined by the orifice 26, corresponding to D1.

Where an increased flow rate is desired, the control unit 12 will operate the regulating valve 10 to open to a certain position, noted opening %. The total flow cross section offered by the regulating arrangement 7 thus corresponds to D1+D2*(opening %).

Where the regulating valve 10 is fully open (opening %=100%), the flow cross-section through discharge piping 5 towards collector 6 is D1+D2.

If D1=D2, then the flow cross section can be doubled when the regulating valve 10 is fully open.

Shut-off valves 17 may advantageously be arranged before and after regulating valve 10 in the conduit 16. These valves 17 are open in operation, and may be closed in order to isolate the regulating valve 10 for maintenance. The regulating valve 10 can thus be serviced without shutting down the whole discharge piping 7.

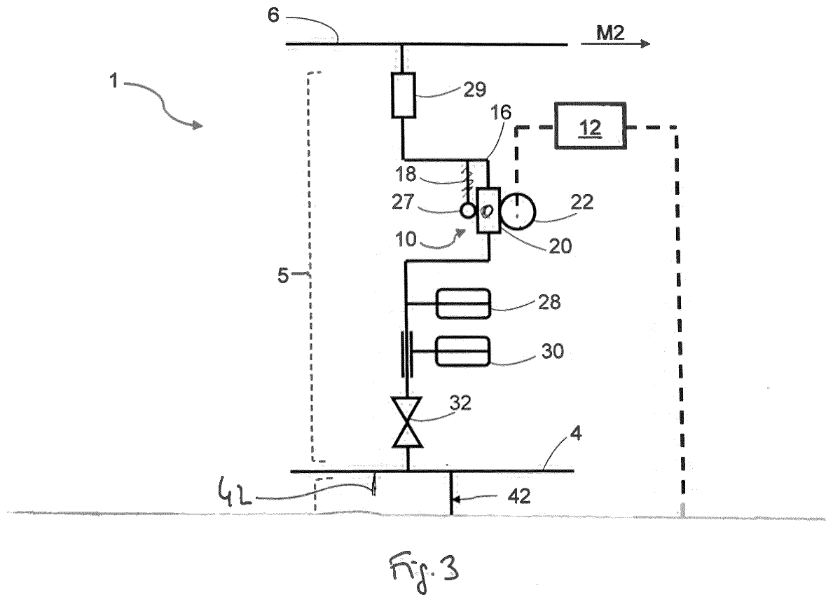

In an alternative embodiment shown in FIG. 3, the calibrated orifice 27 may be integrated in the regulating valve 10, whereby the latter is capable of allowing the default flow of the fluid through piping 18 when the valve is closed. The orifice 27 can e.g. be arranged in the valve body, but preferably in the moveable valve member, namely in the flap or gate member of the valve.

As can be further derived from FIG. 1, for the purpose of coolant state monitoring, a temperature sensor 28 and a flow meter 30 are arranged in piping 18, and optionally a pressure sensor. The temperature sensor 28 and the flow meter 30 may be electrically connected to the control unit 12. Reference sign 32 designate a valve at the entry of the second section 5b, which allows opening or closing flow of fluid into this section.

An additional shut-off valve 29 arranged on the downstream side of second section 5b, allows opening or closing the flow from the discharge piping 5 to the main collector 6. Closing valves 29 and 32 allows isolating the regulating arrangement for maintenance purposes. Since valves 29 and 32 are typically used for maintenance or in case of emergency, they are generally manual valves. It is however possible to equip one or both of them with actuators for remote actuation, e.g. via control unit 12.

As can be further noticed from FIG. 1, the regulating arrangement 7 further comprises a sensor device 14, namely a temperature sensor, which generates a sensor signal representative of the coolant temperature within the cooling arrangement 40, in particular within the pipes 36 between two neighboring cooling elements 34. The sensor device 14 transmits its signals to the control unit 12.

The control unit 12 is configured to operate the regulating valve depending on the measured temperature in the cooling arrangement 40. Basically, at low temperatures, the valve 10 is closed; it will come into play when the measured temperature reaches a threshold. The control unit may e.g. include a table defining the valve opening vs. measured temperatures. Alternatively, the control unit may operate a closed loop control system, whereby the valve is operated (increasing or decreasing the flow cross-section) to reach a given target temperature in the cooling arrangement.

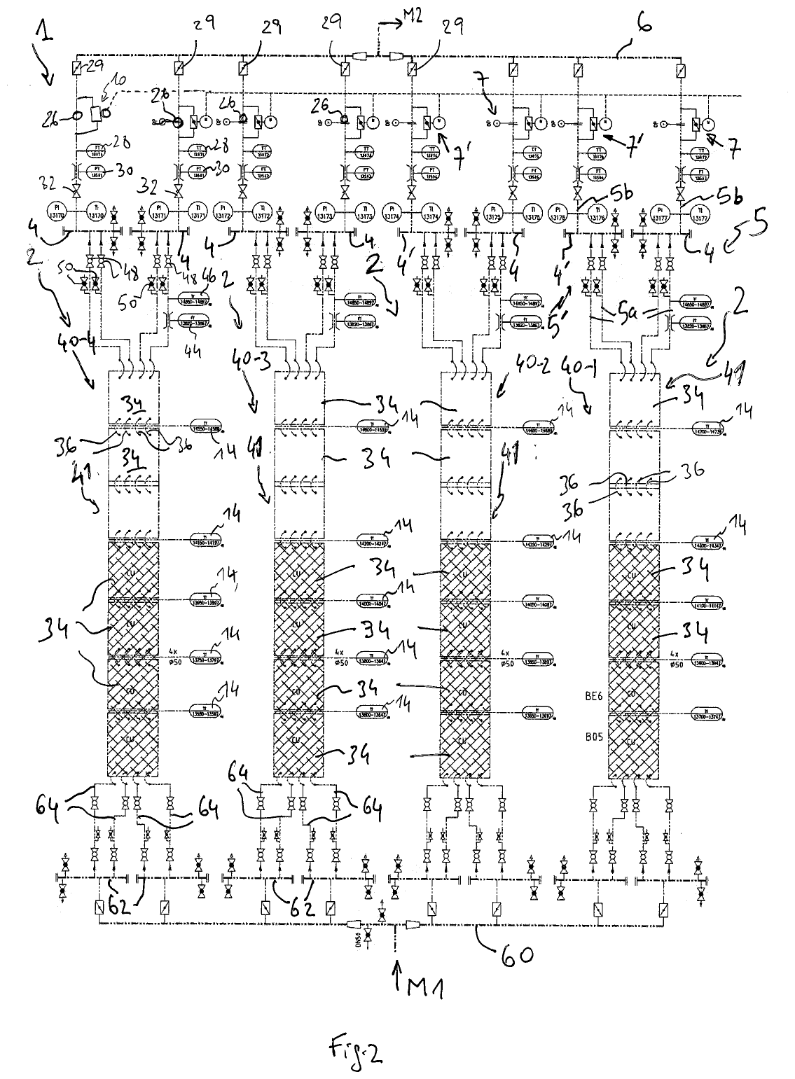

FIG. 2 schematically illustrates another embodiment of the cooling system, with a plurality of cooling arrangements located in different regions of a furnace (not shown). Having regard to FIG. 1, same reference signs are used to designate same or similar elements.

Each of the four cooling arrangements 40-1 to 40-4 comprises a plurality of cooling elements 34. As is known in the art, these cooling elements are typically arranged along the internal side of a shaft/blast furnace jacket, i.e. a generally cylindrical metal wall forming the furnace outer wall. The cooling elements typically have a plate-like shape and a layer of refractory material is initially formed in front of the cooling elements to protect their inner, hot face, as is known in the art. The lower cooling elements (hatched) are located in the lower region of the furnace, where temperatures are higher; these cooling elements may comprise a copper (alloy) body. In the upper region, exposed to lower temperatures, the cooling elements may comprise a cast iron body.

As can be derived from FIG. 2, the cooling elements 34 in each arrangement 40 are in fluid communication with one another by a plurality of pipes 36 for guiding the coolant fluid. In the shown embodiment, each cooling element 34 comprises four internal coolant channels, which are connected in series between the cooling elements.

On the upstream side, the inlet coolant flow M1 is conditioned in a conventional system (not shown) so that the main flow M1 has a desired temperature and pressure. Such conventional system may include one or more pumps, filters, etc. The inlet flow M1 is distributed from a main distributor 60 (or manifold) to intermediate distributors 62, and from there through inlet ducts 64 associated with the internal coolant channels. The intermediate distributors 62 supply the coolant to a set of inlet ducts 64.

In the shown embodiment, the inlet ducts 64 are grouped by pairs. The cooling elements 34 comprise four cooling channels, whereby two intermediate distributors 62 are used for each cooling arrangement 40. Each intermediate distributor 62 is connected to two internal coolant channels via respective inlet ducts 64.

The cooling elements 34 are arranged inside the furnace to cover the furnace metal jacket, i.e. vertically and horizontally (i.e. circumferentially). In FIG. 2, the set of cooling elements 34 of each cooling arrangement 2 are connected serially in the vertical direction.

Within each cooling arrangement 2, the cooling elements 34 extend from lower to upper furnace regions, and the cooling elements are serially connected. The coolant will thus flow successively through each cooling element 34 of the respective cooling arrangement 2, from bottom to top.

In the presentation of FIG. 2, each cooling arrangement 40-1 to 40-4 is shown with one vertical column, indicated 41, of cooling elements 34 (here seven). In practice, each cooling arrangement 40-1 to 40-4 includes several such columns 41, in parallel. The cooling elements 34 within one column 41 are serially connected. The number of cooling elements 34 and the number of columns 41 in each cooling arrangement 40-1 to 40-4 depend on the size of the blast furnace. For example, a column 41 may include between 4 and 15 cooling elements 34, and the number of columns 41 in the respective cooling arrangement 40 may range from 6 to 20. These are only exemplary values and should not be construed as limiting.

Hence in practice each cooling arrangement 40-1 to 40-4 comprises a plurality of columns 41 of cooling elements 34 that are mounted to cover a given angular portion of the shaft furnace, over the height thereof, so that one could say that the cooling arrangement corresponds to an angular sector, or possibly to a quadrant, of the shaft furnace.

Referring particularly to the embodiment of FIG. 2, there are four cooling arrangements 40-1 to 40-4 that each comprise a number of parallel columns 41 of cooling elements appropriate to cover ¼ of the blast furnace circumference, i.e. 90°. Hence, each cooling arrangement 40 corresponds to a quadrant (indicated 2).

On the downstream side of the cooling system, the hot coolant discharged from the cooling arrangements 2 is collected in collector 6. The flow M2 is typically directed to a basin and/or cooling towers, before being recycled.

Each cooling arrangement 40 is connected by at least one discharge piping 5 to the main collector 6. More precisely, this embodiment uses two discharge pipings 5, 5′ (with flow regulating arrangement 7, 7′) per cooling arrangement 40. The configuration of the discharge pipings 5 is similar to that of FIG. 1.

The flows of the internal coolant channels are distributed on the two discharge pipings 5, 5′. As will be understood from FIG. 2, half (here two) of the coolant channels of the uppermost (or downstream-most) cooling elements 34 of each arrangement 40 are connected, via a first section 5a, to a first intermediate collector 4 that is in turn connected to second section 5b, which integrates flow regulating arrangement 7. The other part of the coolant channels of each of the uppermost cooling elements 34 of the cooling arrangement 40 is connected, via sections 5a′, to a second intermediate collector 4′ that is in turn connected to the second section 5b′, which integrates flow regulating arrangement 7′.

The cooling system 1 illustrated by FIG. 2 permits that the flow rates through different cooling arrangements 40, respectively sector(s)/quadrant(s), may be adjusted individually, from the downstream side. As can be further derived from FIG. 2, at least two discharge pipings 5,5′ with regulating arrangement 7,7′ are arranged in parallel to operate a cooling arrangement 40, whereby each discharge piping 5, 5′ receives half of the coolant flow through the concerned quadrant.

The discussed embodiments are examples of the disclosure. In the case of the embodiments, the described components of the respective embodiment each represent individual features of the disclosure which are to be considered independently of each other and which also further develop the disclosure independently of each other. The features are thus also to be regarded as components of the disclosure individually or in a combination other than the combination shown. Furthermore, the described embodiments can also be supplemented by further features of the disclosure already described.

Further features and embodiments of the disclosure result for the skilled person in the context of the present disclosure and the claims.

1. Cooling system for a metallurgical furnace comprising:
a plurality of cooling arrangements comprising each a set of cooling elements arranged to extract heat from the furnace, the cooling elements having each at least one internal cooling channel for a coolant fluid, wherein the cooling elements are fluidly connected within each cooling arrangement;
at least one discharge piping associated with each cooling arrangement for discharging the coolant fluid from the cooling arrangement towards a main collector;
wherein a flow regulating arrangement is serially integrated within the discharge piping and configured to control a flow rate of the coolant fluid therethrough and hence through the cooling arrangement;
wherein the flow regulating arrangement includes a calibrated orifice defining a default, minimal flow cross section for the coolant fluid and a regulating valve selectively operable to define a variable, additional flow cross-section.

2. Cooling system according to claim 1, wherein the regulating valve is an automatic valve controlled by a control unit depending on sensor signal(s) received from one or more sensor device(s) arranged at predetermined locations in the cooling arrangements.

3. Cooling system according to claim 2, wherein one or more sensor device(s) include temperature sensors arranged at predetermined locations within each cooling arrangement; and the control unit is configured to actuate the regulating valve based on the temperature determined from the sensor signal(s).

4. Cooling system according to claim 1, wherein the regulating valve includes a movable valve member, and wherein the calibrated orifice is arranged in the valve member.

5. Cooling system according to claim 1, wherein the flow regulating arrangement comprises:
a first conduit (18) connected to receive the entire coolant flow from the cooling arrangement, said calibrated orifice being arranged in said first conduit; and
a second conduit parallel to said first conduit, which comprises the regulating valve.

6. Cooling system according to claim 5, wherein the second conduit is connected upstream and downstream of the calibrated orifice, forming a bypass.

7. Cooling system according to claim 1, wherein the regulating valve comprises a butterfly valve or gate valve.

8. Cooling system according to claim 2, wherein the sensor device comprises one or more of a temperature sensor, a flow sensor and a pressure sensor.

9. Cooling system according to claim 2, wherein the discharge piping further comprises one or more of a second temperature sensor, a flow meter, a pressure sensor and a manual valve (32).

10. Cooling system according to claim 1, wherein the cooling elements are in fluid communication with one another, wherein the cooling elements are arranged vertically and/or horizontally to one another.

11. Cooling system according to claim 1, wherein each cooling arrangement of the plurality of cooling arrangements is arranged to cover a predetermined angular sector of a furnace.

12. Cooling system according to claim 1, wherein the discharge piping comprises a first section, wherein the first section comprises an exit line for conducting the fluid towards an intermediate collector, and wherein the exit line comprises at least one of a flow meter, a temperature sensor, a shuttle valve and a venting device.

13. Cooling system according to claim 1, wherein each cooling arrangement is composed of a plurality of vertical columns of cooling elements comprising a plurality of cooling channels; and within each column, the cooling elements are fluidly connected in series.

14. Cooling system according to claim 13, wherein part of the internal coolant channels of the downstream-most cooling elements of the cooling arrangement are connected to a first intermediate collector of a first discharge piping with integrated flow regulating arrangement; and the other part of the internal coolant channels of the downstream-most cooling elements of the cooling arrangement are connected to a second intermediate collector of a second discharge piping with integrated flow regulating arrangement.

15. A shaft furnace, in particular a blast furnace comprising an outer metal jacket and a cooling system according to claim 1, wherein the cooling elements are arranged in rows and columns to protect the outer metal jacket, wherein the cooling arrangements are configured to each cover a respective angular sector.

16. The shaft furnace according to claim 15, wherein the cooling system comprises four cooling arrangements, each covering one quadrant of the furnace circumference.
